(19) United States
(12) Patent Application Publication
(10) Pub. No.: US 2026/0037328 A1
(43) Pub. Date: Feb. 5, 2026

(54) ARTIFICIAL INTELLIGENCE (AI) POWERED DATA INTEGRATION IN MULTI-CONTROLLER ENVIRONMENTS

(71) Applicant: Cisco Technology, Inc., San Jose, CA (US)

(72) Inventors: Jerome Henry, Pittsboro, NC (US); Robert Edgar Barton, Richmond (CA); Vinay Saini, Bangalore (IN)

(21) Appl. No.: 18/794,863

(22) Filed: Aug. 5, 2024

(51) Int. Cl. G06F 9/50; G06F 9/451

(52) U.S. Cl. CPC G06F 9/505; G06F 9/451

(57) ABSTRACT

This disclosure describes techniques and mechanisms for a system to integrate data from multiple controllers such that a user may manage and/or have visibility to the multiple controllers from a single management platform and/or dashboard. For example, each of the multiple controllers may be associated with a large language model (LLM) that may be trained on a functionality associated with the controller, as well as the structure of the user interface associated with the controller. Using data associated with the secondary controller and output by the LLM of the secondary controller, the data may be used by the primary controller and the LLM of the primary controller such that data of the secondary controller (e.g., command data and/or user interface data) may be integrated with data of the primary controller (e.g., command data and/or user interface data) at a single controller management system and/or dashboard.

### TECHNICAL FIELD

The present disclosure relates generally to the field of computer networking, and more particularly to data integration within a multi-controller environment using artificial intelligence (AI), such as a Large Language Model (LLM).

### BACKGROUND

Computer networks are generally a group of computers or other devices that are communicatively connected and use one or more communication protocols to exchange data. For instance, computer networking can refer to connected computing devices (such as laptops, desktops, servers, smartphones, and tablets) as well as an ever-expanding array of Internet-of-Things (IOT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect devices associated with individual users or LANs, Enterprise Networks that are built for a large organization, Internet Service Provider (ISP) Networks that operate WANs to provide connectivity to devices associated with individual users or enterprises, software-defined networks (SDNs), wireless networks, core networks, cloud networks, and so forth.

These networks often include specialized network devices to communicate packets representing various data from device-to-device, such as switches, routers, servers, access points, etc. Each of these devices is designed and configured to perform different networking functions. In networking environments, network controllers are critical to the management and orchestration of network functions and devices. For example, network controllers may generally configure network devices, collect and analyze telemetry data from the network and/or network devices, distribute desired policies across the network, and/or the like. Different controllers, which may be from different third-parties and/or vendors, may be configured to manage the networking environment and/or objects in the environment (e.g., IoT controllers, voice platforms for managing audio-video applications, controllers for managing security policies in the network, etc.). As such, the use of a plurality of different controllers has become commonplace for businesses, enterprises, etc. However, the use of multiple different controllers, and their associated management platforms and/or user interfaces, has become complicated. For example, the access and use of controllers, especially controllers from different vendors, are typically siloed. As such, a user, such as a network administrator, may be required to jump from controller to controller and their related platforms. Further, the use of multiple different controllers may create implications into the management of the network objects themselves. For example, an action taken and/or change with respect to one controller may effect network connections associated with a different controller.

Accordingly, a need exists for systems and methods enabling a dynamic and intelligent way to configure a management platform such that a plurality of controllers may be managed in an integrated and unified manner, or “single-pane of glass.”

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment in which LLMs associated with two or more controllers may be used to integrate controller data in a management platform.

FIG. 2 illustrates a diagram of components of an example controller described in FIG. 1.

FIG. 3 illustrates a flow diagram for an example process for using LLMs associated with two or more controllers in order to integrate controller data associated with the two or more controllers.

FIG. 4 illustrates an example user interface including integrated controller data of a multi-controller environment.

FIG. 5 illustrates a flow diagram of an example method for the integration of controller data of a multi-controller environment using LLMs.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for the integration of controller data (e.g., commands and/or workflows for monitoring and/or configuring, user interface data, etc.) of a multi-controller environment using AI, such as an LLM.

A method to perform the techniques described herein includes receiving, at a multi-controller management platform, user input selecting a first controller and a second controller, wherein the first controller is associated with a first large language model (LLM) and the second controller is associated with a second LLM, and receiving, from the first LLM, workflow data including a first workflow of the first controller and first user interface (UI) attributes of the first workflow, wherein the first UI attributes are associated with the first controller. The method may further include receiving, from the second LLM, a first indication of the first workflow, wherein the first indication is based at least in part on the workflow data and second UI attributes of the second controller, generating, at the multi-controller management platform, a representation including the first indication and a second indication of a second workflow associated with the second controller, and causing display of the representation at a user interface associated with the second controller.

Additionally, the techniques described herein may be performed by a system and/or device having non-transitory computer-readable media storing computer-executable instructions that, when executed by one or more processors, performs the method described above.

### Example Embodiments

Various implementations of the present disclosure provide techniques for the integration of controller data of a multi-controller environment using AI, such as an LLM. As discussed above, there are several limitations for the use of controllers in a multi-controller environment. Traditionally, different controllers, which may be from different third-parties and/or vendors, may be configured to manage the networking environment and/or objects in the environment (e.g., IoT controllers, voice platforms for managing audio-video applications, controllers for managing security policies in the network, etc.). As such, the use of a plurality of different controllers has become commonplace for businesses, enterprises, etc. However, the use of multiple different controllers, and their associated management platforms and/or user interfaces, has become complicated. For example, the access and use of controllers, especially controllers from different vendors, are typically siloed. Further, any attempts at the integration of different controllers have typically involved a user interface component (e.g., a button) that is selectable by a user to launch a management platform associated with another controller. As such, a user, such as a network administrator, may be required to jump from controller to controller and their related platforms. Further, the use of multiple different controllers may create implications into the management of network objects themselves. For example, an action taken and/or change with respect to one controller may effect network connections associated with a different controller. Additionally, the use of AI technology, such as LLMs, has become widespread. AI technology is also well established as a resource used by many enterprises and/or organizations to increase efficiencies and automate natural language tasks. While LLMs may be trained on content related to webpages such as Hyper Text Markup Language (HTML) structure in order to automate web-based tasks, such training is limited and may provide unnecessary information for a user.

Accordingly, a need exists for systems and methods enabling a dynamic and intelligent way to configure a management platform such that a plurality of controllers may be managed in an integrated and unified manner, or “single-pane of glass.” Further, AI, such as an LLM, may be leveraged to configure such a management platform.

This disclosure describes techniques and mechanisms for a system to integrate data from multiple controllers such that a user may manage and/or have visibility to the multiple controllers from a single management platform and/or dashboard. In some examples, the system, such as a system of a multi-controller management platform, may be associated with multiple network controllers of a network. Each of the multiple network controllers may be associated with AI, such as an LLM, that may be trained on a purpose and/or data type associated with a network controller. For example, the purpose and/or data type associated with the network controller may include controller commands and/or workflows to perform a functionality associated with the controller (e.g., configuration workflows and/or monitoring workflows). Additionally, or alternatively, the LLM may be trained on user interface data associated with the network controller (e.g., the structure of the user interface associated with the network controller). Further, the system may receive user input data indicating a first controller (i.e., primary controller) and a second controller (i.e., secondary controller) that the user may wish to control and/or operate. Using the secondary controller and associated LLM, the system may receive command data associated with the secondary controller. Additionally, or alternatively, using the secondary controller and associated LLM, the system may receive user interface data associated with the command data and/or the secondary controller. The command data and user interface data may be included together as workflow data. In some instances, using the primary controller and associated LLM, the system may receive an output including a translation of workflow data associated with the secondary controller, where the translation may include the command data and the user interface data associated with the secondary controller translated to the structure of the user interface associated with the primary controller. The output may then be used at the primary controller such that data of the secondary controller (e.g., command data and/or user interface data) may be integrated with data of the primary controller (e.g., command data and/or user interface data) at a single controller management system and/or dashboard.

In some examples, the system may comprise multiple network controllers that may be present, or installed, in a network environment. The multiple network controllers may be configured to orchestrate network functions (e.g., monitor an inventory of devices in the network and their status, analyze network operations, automate device configurations, etc.). For example, a first controller may be associated with monitoring the overall operational status of network devices and/or configuring the network devices (e.g., routers, switches, etc.). Additionally, or alternatively, a second controller may be associated with authenticating users and configuring network access control, such as by enforcing policies. The second controller may also be configured to use data such as user group, device type, access time, access location, access type, and/or the like to create policies for network access. Additionally, or alternatively, the multiple network controllers may be associated with different access rights. For example, a user, such as a network administrator, may have an access level such that they are granted a general view of the controller, command access control, and/or the like.

The multiple network controllers may also each be associated, or embedded with, with a generative AI tool, such as an LLM. For example, the LLM may be configured to understand and generate human-like text in performing various tasks (e.g., text generation, responding to user input such as questions, text translation, etc.). In some instances, the LLM may be trained on large amounts of data, such as configuration data (e.g., a functionality and/or data type associated with a controller). The configuration data may include various command structures and/or workflows of the controller associated with the LLM. For example, an LLM associated with the first controller may be trained such that the LLM may receive user input data, such as in the form of a question and/or request, to configure a network device in a certain manner. The LLM may then output workflow data including the workflow and/or configuration commands for configuring the network device. In some instances, the workflow data may include a workflow and commands for monitoring the network and/or network objects.

Additionally, or alternatively, the LLM may be trained on the semantic data of the user interface (e.g., webpage) of its respective controller. For example, the LLM associated with the first controller may be trained on the semantic data of the first controller, and/or the LLM associated with the second controller may be trained on the semantic data of the second controller. The semantic data may include HyperText Markup Language (HTML) and/or Extensible Markup Language (XML) code representing the structure of the webpage, the content of the webpage, and/or the like. By way of example, and not limitation, the semantic data may include an indication such as pages and/or tabs included in the webpage. For example, the semantic data associated with the first controller may include an indication of tabs for monitoring the overall operational status of network devices. Additionally, or alternatively, the semantic data associated with the second controller may include an indication of tabs for creating policies for network access. The LLM of a network controller may be trained on the semantic data such that, in response to a user request, the LLM may output user interface data corresponding to workflows and/or commands for its respective controller. In some instances, the LLM of a network controller may be trained on the semantic data such that, in response to a user request, the LLM may output application programming interface (API) calls that may enable a user to remotely execute workflows associated with a controller functionality and via a user interface. The user interface data and/or API calls for a respective controller generated by an LLM may be included with the workflow data.

In some examples, the system may be associated with a multi-controller management service, such as a management platform, at which a user may provide user input selecting a primary controller, such as the first controller described above. The user may select the primary controller based on a user preference, familiarity with the primary controller, access level, etc. Additionally, or alternatively, the user may select a secondary controller, such as the second controller described above, that the user would like to control. While the network environment, as described, may include a first controller and second controller, the network environment may include any number of network controllers. Accordingly, the user may select a third controller present in the environment that the user would like to control. The user may select the third controller in addition to the secondary controller and the primary controller. As such, any of the processes described herein may include the third controller.

Upon the selection of the primary controller and the secondary controller (and/or the third controller), the system may be configured to receive workflow data from the secondary controller. For example, using the LLM associated with the secondary controller, the LLM may output workflow data indicating commands and/or workflows associated with a task (e.g., configuring and/or monitoring a network device). In some instances, the LLM may output the workflow data associated with the task, where the task is provided as user input from a user. For example, the user may ask the LLM associated with the secondary controller to configure a user's rights in a network, monitor the battery status of certain network devices, monitor quality of service (QoS) data associated with an audio call, and/or the like. Accordingly, the LLM may output the corresponding configuration commands and/or workflows. In some instances, the commands and/or workflows included in the workflow data and output by the LLM may be based on access rights associated with the user (e.g., whether the user has access to generally view the controller, command access control, and/or the like).

Additionally, or alternatively, using the LLM associated with the secondary controller, the LLM may output the user interface data and/or API calls to remotely execute commands and/or workflows. In some instances, the LLM may output the user interface data and/or API calls associated with the configuration commands and/or workflows in response to user input. For example, the user may ask the LLM associated with the secondary controller to output user interface data and/or API calls associated with configuration commands and/or workflows described above. In some instances, such as when the user asks the LLM associated with the secondary controller to output user interface data associated with configuration commands and/or workflows, the LLM may output an HTML code representing a user interface associated with the execution of the configuration commands and/or workflows. For example, the HTML code may represent a user interface including tabs, pages, elements, and/or the like for configuring a user's rights in a network, monitoring the battery status of certain network devices, monitoring quality of service (QoS) data associated with an audio call, and/or the like. The configuration commands, workflows, user interface data, and/or API calls may be included as workflow data.

Upon receipt of the workflow data by the system, the workflow data may be used as input to the LLM associated with the primary controller, where the LLM associated with the primary controller may be configured to output translated workflow data. For example, based on the semantic data of the primary controller used to train the LLM associated with the primary controller, the LLM may output translated workflow data such that the workflow data of the secondary controller is translated to the structure and/or style (e.g., represented as HTML code, XML code, and/or the like) of the user interface of the primary controller. The workflow data may also include the user access rights associated with the secondary controller, which may be used by the LLM associated with the primary controller to output the translated workflow data. The translated workflow data may indicate a representative tab, webpage, dashlet, etc. that may be in the structure and/or style of the primary controller, but includes elements for executing commands associated with the secondary controller. Additionally, or alternatively, the translated workflow data may be integrated into a user interface and/or dashboard such that the user interface includes a dashlet with elements for executing commands associated with the primary controller, as well as the integrated dashlet with elements for executing commands associated with the secondary controller. Thus, the user may use the integrated dashlet and elements for executing commands associated with the secondary controller using the user interface of the primary controller. For example, when the user indicates a command to be executed associated with the secondary controller, the primary controller may use the user access rights associated with the secondary controller and send the command to the secondary controller, where the output of the secondary controller in response to the command may be displayed at the dashlet of the user interface of the primary controller.

In some instances, there may be an overlap (e.g., conflict) between the elements of the dashlet associated with the primary controller and the elements of the integrated dashlet associated with the secondary controller. For example, a network component may be configured by both the primary controller and the secondary controller, such that user interface including the integrated dashlet of the secondary controller and the dashlet of the primary controller may display contradicting policies, contradicting values, state conflicts, and/or the like. Additionally, or alternatively, when there is an overlap between the dashlet of the primary controller and the integrated dashlet of the secondary controller, when a user wishes to execute a command associated with the overlapping element, the system may cause contradicting instructions to be executed with respect to the overlapping element. In some instances, the LLM, such as the LLM associated with the primary controller, may be trained to recognize an overlapping element. For example, when the workflow data associated with the secondary controller is used as input by the LLM associated with the primary controller to output translated workflow data, the LLM associated with the primary controller may be configured to identify, verify, determine, etc. whether the translated workflow data, when included in the user interface of the primary controller as an integrated dashlet of the secondary controller, would have an overlap with the elements of the dashlet of the primary controller (e.g., a conflict in commands executed by the primary controller and secondary controller). Accordingly, the LLM may indicate to the user that such an overlap exits.

The techniques described herein provide various improvements and efficiencies with respect to the operation of controllers in a multi-controller environment. For example, when a user, such as a network administrator requires the use of multiple controllers to manage a network environment and/or devices in the network environment, integrating data from multiple controllers into a single user interface, management platform, and/or dashboard enables the user to manage and/or have visibility to the multiple controllers without having to toggle between controllers. This way, the data associated with different controllers may be presented in a compact way that makes it easier for the user to both understand the data from different controllers as well as accomplish tasks.

The techniques described herein are with reference to a service provider network, such as a cloud provider network or platform. However, the techniques are equally applicable to any network and in any environment. For example, the system may be associated with an on-premises network.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations set forth herein. The disclosure encompasses variations of the embodiments as described herein.

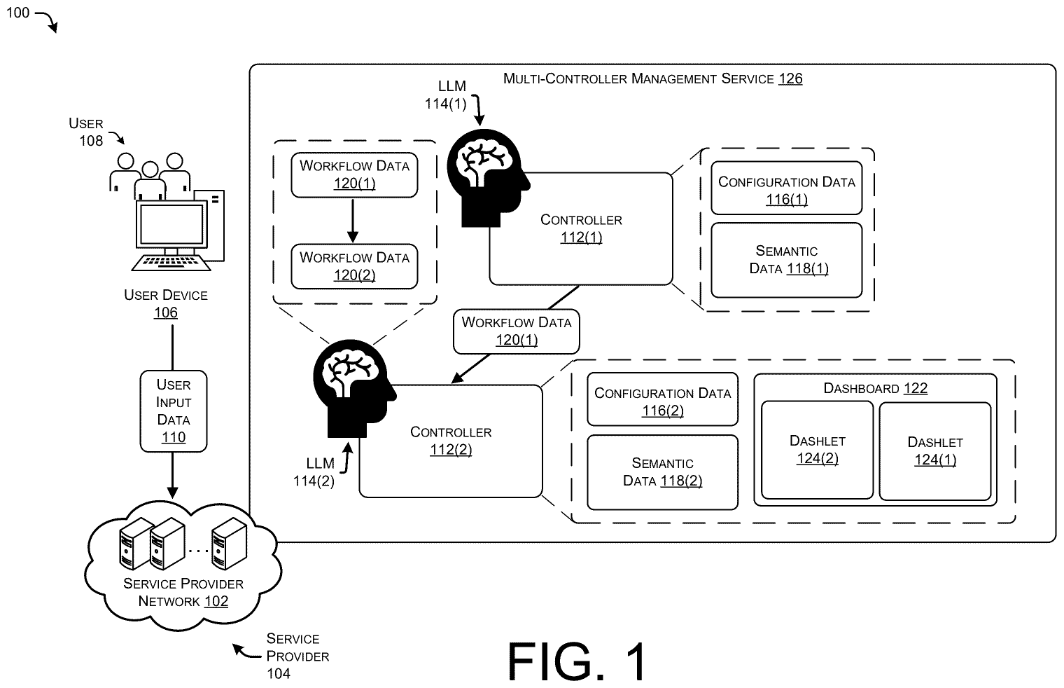

FIG. 1 illustrates an example environment 100 in which LLMs 114 associated with two or more controllers 112 may be used to integrate controller data in a management platform, such as a platform associated with multi-controller management service 126.

In some examples, the service provider network 102 of a service provider 104 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 102 may be an on-premises network, a private network of a corporation, and/or any other type of network or combination thereof.

In some instances, the multi-controller management service 126 may be a scalable service that includes and/or runs on devices housed or located in one or more data centers that may be located at different physical locations. The multi-controller management service 126 may be supported by networks of devices in a public cloud computing platform, a private/enterprise computing platform, and/or any combination thereof. The one or more data centers may be physical facilities or buildings located across geographic areas that are designated to store network devices that are part of and/or support the multi-controller management service 126. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

In some examples, the service provider network 102 may comprise controllers 112 that may be present, or installed, in a network environment. The controllers 112 may be configured to orchestrate network functions (e.g., monitor an inventory of devices in the network and their status, analyze network operations, automate device configurations, etc.). For example, controller 112(2) may be associated with monitoring the overall operational status of network devices and/or configuring the network devices (e.g., routers, switches, etc.). Additionally, or alternatively, controller 112(1) may be associated with authenticating users and configuring network access control, such as by enforcing policies. The controller 112(1) may also be configured to use data such as user group, device type, access time, access location, access type, and/or the like to create policies for network access. Additionally, or alternatively, the controllers 112 may be associated with different access rights. For example, a user 108, such as a network administrator, may have an access level such that they are granted a general view of the controllers 112, command access control, and/or the like.

The multiple network controllers may also each be associated, or embedded with, with a generative AI tool, such as an LLM 114. For example, the LLM 114 may be configured to understand and generate human-like text in performing various tasks (e.g., text generation, responding to user input such as questions, text translation, etc.). In some instances, the LLM 114 may be trained on large amounts of data, such as configuration data 116 (e.g., a functionality and/or data type associated with a controller 112). The configuration data 116 may include various command structures and/or workflows of the controller 112 associated with the LLM 114. For example, LLM 114(2) associated with the controller 112(2) may be trained such that the LLM 114(2) may receive user input data 110, such as in the form of a question and/or request, to configure a network device in a certain manner. The LLM 114(2) may then output workflow data 120 including the workflow and/or configuration commands for configuring the network device. In some instances, the workflow data may include a workflow and commands for monitoring the network and/or network objects.

Additionally, or alternatively, the LLMs 114 may be trained on semantic data 118 of the user interface (e.g., webpage) of its respective controller 112. For example, the LLM 114(2) associated with the controller 114(2) may be trained on the semantic data 118(2) of the controller 114(2), and/or the LLM 114(1) associated with the controller 112(1) may be trained on the semantic data 118(1) of the controller 112(1). The semantic data 118 may include HyperText Markup Language (HTML) and/or Extensible Markup Language (XML) code representing the structure of the webpage, the content of the webpage, and/or the like. By way of example, and not limitation, the semantic data 118 may include an indication such as pages and/or tabs included in the webpage. For example, the semantic data 118(2) associated with the controller 112(2) may include an indication of tabs for monitoring the overall operational status of network devices. Additionally, or alternatively, the semantic data 118(1) associated with the controller 112(1) may include an indication of tabs for creating policies for network access. The LLMs 114 of the controllers 112 may be trained on the semantic data 118 such that, in response to a user request indicated by user input data 110, the LLMs 114 may output user interface data corresponding to workflows and/or commands for its respective controllers 112. In some instances, the LLMs 114 of the controllers 112 may be trained on the semantic data 118 such that, in response to a user request indicated by user input data 110, the LLMs 114 may output application programming interface (API) calls that may enable a user 108 to remotely execute workflows associated with a controller 112 functionality and via a user interface. The user interface data and/or API calls for a respective controller 112 generated by an LLM 114 may be included with the workflow data 120.

In some examples, service provider network 102 may be associated with a multi-controller management service 126, such as a management platform, at which a user 108 may provide user input data 110 selecting a controller 112(2), such as controller 112(2) described above, via user device 106. User device 106 may communicate over networks, such as the Internet. In some instances, the network may generally comprise one or more networks implemented by any viable communication technology, such as wired and/or wireless modalities and/or technologies. The network may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network may include devices, virtual resources, or other nodes that relay packets from one device to another. The user device 106 may comprise any type of electronic device capable of communicating using email communications. For instance, the user device 106 may include one or more of different personal user devices, such as desktop computers, laptop computers, phones, tablets, wearable devices, entertainment devices such as televisions, and/or any other type of computing device.

The user 108 may select the controller 112(2) based on a user preference, familiarity with the controller 112(2), access level, etc. Additionally, or alternatively, the user 108 may select a controller 112(1), such as controller 112(1) described above, that the user 108 would like to control. While service provider network 102, as described, may include controller 112(1) and/or controller 112(2), the service provider network 102 may include any number of network controllers. Accordingly, the user 108 may select a third controller present in the environment that the user would like to control. The user may select the third controller in addition to the controller 112(1) and the controller 112(2).

Upon the selection of the controller 112(1) and the controller 112(2) (and/or the third controller), the multi-controller management service 126 may be configured to receive workflow data 120(1) from the controller 112(1). For example, using the LLM 114(1) associated with the controller 112(1), the LLM 114(1) may output workflow data 120(1) indicating commands and/or workflows associated with a task (e.g., configuring and/or monitoring a network device). In some instances, the LLM 114(1) may output the workflow data 120(1) associated with the task, where the task is provided as user input data 110 from a user 108. For example, the user 108 may ask the LLM 114(1) associated with the controller 112(1) to configure a user's rights in a network, monitor the battery status of certain network devices, monitor quality of service (QoS) data associated with an audio call, and/or the like. Accordingly, the LLM 114(1) may output the corresponding configuration commands and/or workflows, which may be included as workflow data 120(1). In some instances, the commands and/or workflows included in the workflow data 120(1) and output by the LLM 114(1) may be based on access rights associated with the user 108 (e.g., whether the user has access to generally view the controller, command access control, and/or the like).

Additionally, or alternatively, using the LLM 114(1) associated with the controller 112(1), the LLM 114(1) may output the user interface data and/or API calls to remotely execute commands and/or workflows. In some instances, the LLM 114(1) may output the user interface data and/or API calls associated with the configuration commands and/or workflows in response to user input data 110. For example, the user 108 may ask the LLM 114(1) associated with the controller 112(1) to output user interface data and/or API calls associated with configuration commands and/or workflows described above. In some instances, such as when the user asks the LLM 114(1) associated with the controller 112(1) to output user interface data associated with configuration commands and/or workflows, the LLM 114(1) may output an HTML code representing a user interface associated with the execution of the configuration commands and/or workflows. For example, the HTML code may represent a user interface including tabs, pages, elements, and/or the like for configuring a user's rights in a network, monitoring the battery status of certain network devices, monitoring quality of service (QoS) data associated with an audio call, and/or the like. The configuration commands, workflows, user interface data, and/or API calls may be included as workflow data 120(1).

Upon receipt of the workflow data 120(1) by the system, the workflow data 120(1) may be used as input to the LLM 114(2) associated with the controller 112(2), where the LLM 114(2) associated with the controller 112(2) may be configured to output translated workflow data 120(2). For example, based on the semantic data 118(2) of the controller 112(2) used to train the LLM 114(2), the LLM 114(2) may output translated workflow data 120(2) such that the workflow data 120(1) of the controller 112(1) is translated to the structure and/or style (e.g., represented as HTML code, XML code, and/or the like) of the user interface of the controller 112(2). The workflow data 120(1) may also include the user access rights associated with the controller 112(1), which may be used by the LLM 114(2) associated with the controller 112(2) to output the translated workflow data 120(2). The translated workflow data 120(2) may indicate a representative tab, webpage, dashlet, etc. that may be in the structure and/or style of the controller 112(2), but includes elements for executing commands associated with the controller 112(1). Additionally, or alternatively, the translated workflow data 120(2) may be integrated into a user interface and/or dashboard, such as dashboard 122, such that the dashboard 122 includes a dashlet 124(1) with elements for executing commands associated with the controller 112(2), as well as the integrated dashlet 124(1) with elements for executing commands associated with the controller 112(1). Thus, the user 108 may use the integrated dashlet 124(1) and elements for executing commands associated with the controller 112(1) using the dashboard 122 of the controller 112(2). For example, when the user 108 indicates a command to be executed associated with the controller 112(1), the controller 112(2) may use the user access rights associated with the controller 112(1) and send the command to the controller 112(1), where the output of the controller 112(1) in response to the command may be displayed at the dashlet 124(1) of the dashboard 122 of the controller 112(2).

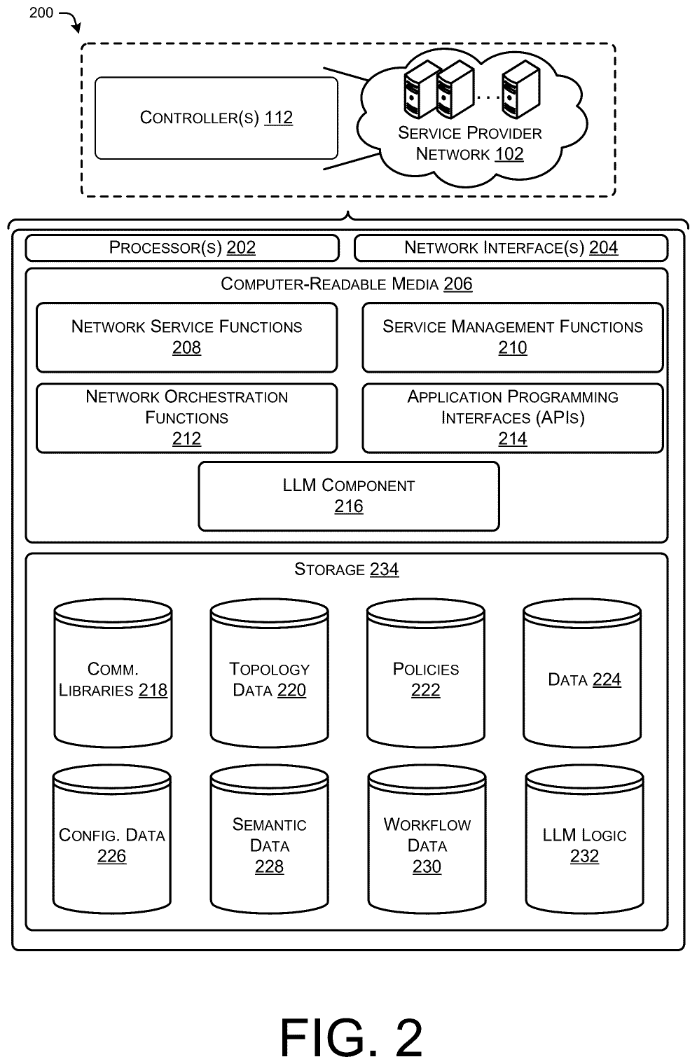

FIG. 2 illustrates an example diagram 200 of components of the controller 112. As illustrated, the service provider network 102 may be associated the controller 112. The controller 112 may include one or more hardware processor(s) 202 (processors) configured to execute one or more stored instructions. The processors 202 may comprise one or more cores. Further, the controller 112 may include network interface(s) 204 to allow the processor 202 or other portions of the controller 112 to communicate with other devices. The network interface(s) 204 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 may include devices configured to couple to personal area networks (PANs), wired and wireless local area networks (LANs), wired and wireless wide area networks (WANs), and so forth. For example, the network interface(s) 204 may include devices compatible with Ethernet, Wi-Fi™, and so forth.

Controller 112 may also include computer-readable media 206 that stores various executable components (e.g., software-based components, firmware-based components, etc.). In addition to various components discussed in FIG. 1, the computer-readable media 206 may further store components to implement functionality described herein. While not illustrated, the computer-readable media 206 may store one or more operating systems utilized to control the operation of the one or more devices that comprise the controller 112. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 206 may include network service functions 208 that configures the controller 112 to perform various operations described herein. For instance, the network service functions 208 may be configured to, when executed by the processors 202, perform various functions such as a slicing manager, a topology manager to manage a topology of the network associated with the controller 112, a host tracker to track what network components are hosting which programs or software, a switch manager to manage switches of the network associated with the controller 112, a process manager, and/or any other type of function performed by the network controller 112. The computer-readable media 206 may also include one or more service management functions 210 configured to manage the specific services of the network associated with the controller 112 (configurable), and one or more APIs 214 for communicating with devices in the network associated with the controller 112 and causing various controller functions to occur. The computer-readable media 206 may also include network orchestration functions 212 that configures the controller 112 to perform various operations described herein. For instance, network orchestration functions 212 may be configured to, when executed by the processors 202, perform various network functions, such as resource management, creating and managing network overlays, programmable APIs, provisioning or deploying applications, software, or code to hosts, and/or perform any other orchestration functions.

The computer-readable media 206 may include LLM component 216. The LLM component 216 may comprise a machine learning model, such as an LLM. By way of example, and not limitation, other machine learning models, such as a small language model (SLM) and/or any other suitable technique may be used. The LLM component 216 may be configured to receive configuration data and/or UI semantic data associated with a controller, as well as instructions (e.g., user input data) from a user to generate commands and/or workflows associated with a task and user interface data and/or API calls. The LLM component 216 may generate workflow data. The LLM component 216 may also be configured to translate workflow data from one LLM component 216 to the user interface style (e.g., the look and feel) of its corresponding controller 112.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

Additionally, the controller 112 may include storage 234 which may comprise one, or multiple, repositories or other storage locations for persistently storing and managing collections of data such as databases, simple files, binary, and/or any other data. The storage 234 may include one or more storage locations that may be managed by one or more storage/database management systems.

As illustrated, the storage 234 may include communication libraries 218, topology data 220, policies 222, data 224, configuration data 226, semantic data 228, workflow data 230, and/or LLM logic 232. It should be appreciated that the foregoing list is merely exemplary and the storage 234 may include additional elements that may be apparent to one skilled in the art.

Communication libraries 218 may include a database of different communication protocols that the controller 112 is configured to use or perform. The network topology data 220 may include data such as a model representing the layout of the network components in the network associated with the controller 112 and/or data indicating available bandwidth, available CPU, delay between nodes, computing capacity, processor architecture, processor type(s), etc. The policies 222 may include a database including, but not limited to, network policy(ies), network controller policy(ies), security data associated with the network, security policies configured for the network, firewall policies, firewall configuration data, network configuration policies, network configuration data, security posture data, and/or compliance policies configured for the network. The data store 224 may store data including metadata, telemetry data, device inventory data, incident data, processed data, provision failure history, log data, configuration of devices within the enterprise network, data exported from applications, user data associated with user(s) accessing device(s) or application(s) network data, or any other data and/or information described herein.

The configuration data 226 may include a database of configuration data (e.g., a functionality and/or data type associated with a controller). The configuration data 226 may include various command structures and/or workflows of the controller associated with the LLM. The semantic data 228 may include a database of semantic data. The semantic data 228 may include HyperText Markup Language (HTML) and/or Extensible Markup Language (XML) code representing the structure of the webpage, the content of the webpage, and/or the like. By way of example, and not limitation, the semantic data may include an indication such as pages and/or tabs included in the webpage. The workflow data 230 may include a database of workflow data. The workflow data 230 may include a workflow and/or commands for a function associated with the controller 112 (e.g., configuring network devices, monitoring network conditions, etc.) Additionally, or alternatively, the workflow data 230 may include user interface data and/or API calls corresponding to the workflow and/or commands of the controller 112.

The LLM logic 232 may include a database of logic for generating commands and/or workflows associated with a task and corresponding user interface data and/or API calls for a respective controller. For example, the LLM component 216 may reference configuration data 226, semantic data 228, and LLM logic 232 in determining workflow data 230. Additionally, or alternatively, the LLM logic 232 may include a database of logic for translating workflow data 230 from one LLM component 216 to the user interface style (e.g., the look and feel) of its corresponding controller 112. For example, the LLM component 216 may reference semantic data 228 and LLM logic 232 in determining translated workflow data.

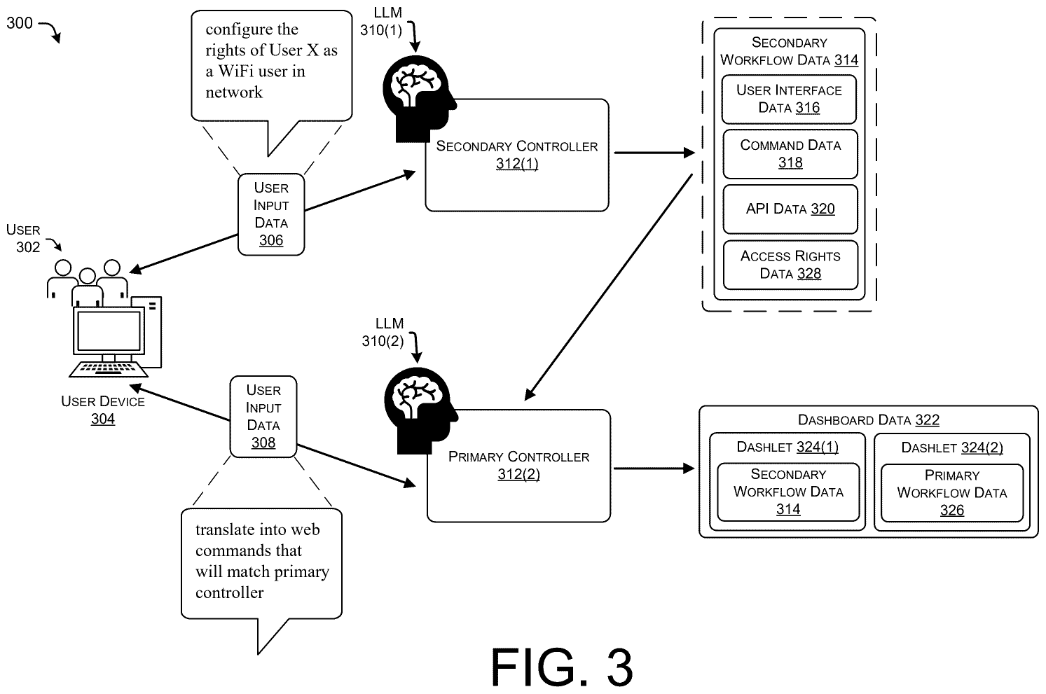

FIG. 3 illustrates a flow diagram for an example process 300 for using LLMs associated 310 with two or more controllers 312 in order to integrate controller data associated with the two or more controllers 312.

A user 302, via user device 304, may select the primary controller 312(2) that they may wish to work from (e.g., based on user preference, familiarity with the primary controller 312(2), access level, etc.). By way of example, and not limitation, the primary controller 312(2) may be associated with configuring network devices (e.g., configuring Open Shortest Path First (OSPF) routing on a switch, provisioning a virtual local area network (VLAN), monitoring network performance, and/or other controller functionalities. The user 302 may also select the secondary controller 312(1) that the user would like to control. By way of example, and not limitation, the secondary controller 312(1) may be associated with configuring a user's rights in a network, monitoring the performance of an audio and/or video call, using data such as user group, device type, access time, access location, access type, and/or the like to create policies for network access (e.g., access rights to a VLAN), and/or other controller functionalities.

Upon selection of the primary controller 312(2) and the secondary controller 312(1) (and/or any number of controllers), the LLM 310(1) associated with the secondary controller 312(1) may output secondary workflow data 314 indicating command data 318 (e.g., commands and/or workflows) associated with a task. As illustrated, user input data 306 may be provided via user device 304 of the user 302, where the user input data 306 indicates a task (e.g., “configure the rights of User X as a WiFi user in network”). Accordingly, the LLM 310(1) may output the corresponding configuration commands and/or workflows as command data 318 included in the secondary workflow data 314. Additionally, or alternatively, the LLM 310(1) may output user interface data 316 and/or API data 320 (e.g., API calls to remotely execute commands and/or workflows) associated with the command data 318 and included with the secondary workflow data 314. The secondary workflow data 314 may also include access rights data 328, which may indicate a user's access level associated with the secondary controller 312(1) (e.g., general view of the secondary controller 312(1), command access control, etc.).

The secondary workflow data 314 may be used as input to the LLM 310(2) associated with the primary controller 312(2), where the LLM 310(2) may be configured to translate the secondary workflow data 314 into the structure and/or style of the primary controller 312(2). For example, upon receipt of the secondary workflow data 314 by the LLM 310(2), the LLM 310(2) may also receive user input data 308 with instructions to translate the secondary workflow data 314 (e.g., “translate into web commands that will match primary controller”). The secondary workflow data 314 may be translated and included as a dashlet 324(1) that is in the structure and/or style of the primary controller 312(2), and displayed at dashboard 322, but including elements for executing commands associated with the secondary controller 312(1) via dashboard 322. Additionally, or alternatively, the secondary workflow data 314 may be translated and integrated into the dashboard 322 associated with the primary controller 312(2) such that the dashboard includes dashlet 324(1) with secondary workflow data 314 and elements for executing commands associated with the secondary controller 312(1), as well as a dashlet 324(2) with primary workflow data 326 with elements for executing commands associated with the primary controller 312(2).

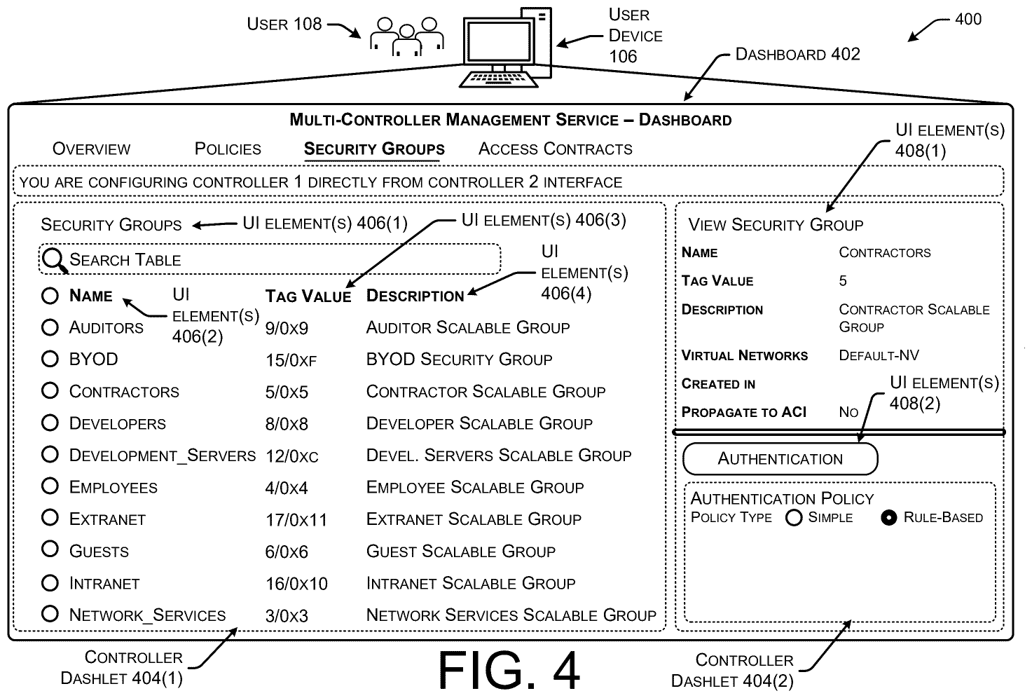

FIG. 4 illustrates an example user interface 400 including integrated controller data of a multi-controller environment.

For example, as described above, the workflow data associated with a secondary controller may be used as input to the LLM associated with the primary controller, where the LLM associated with the primary controller may be configured to output translated workflow data. For example, based on the semantic data of the primary controller used to train the LLM associated with the primary controller, the LLM may output translated workflow data such that the workflow data of the secondary controller is translated to the structure and/or style (e.g., represented as HTML code, XML code, and/or the like) of the user interface 400 of the primary controller. For example, the user interface 400 may include a dashboard 402 displayed to the user 108 via user device 106. The translated workflow data may indicate a controller dashlet 404(2) that may be in the structure and/or style of the primary controller, such as dashboard 402, but includes UI elements 408 for executing commands associated with the secondary controller.

Additionally, or alternatively, the translated workflow data may be integrated into the dashboard 402 such that the dashboard 402 includes a controller dashlet 404(1) with elements 406 for executing commands associated with the primary controller, as well as the controller dashlet 404(2) with elements 408 for executing commands associated with the secondary controller. Thus, the user 108 may use the controller dashlet 404(2) and UI elements 408 for executing commands associated with the secondary controller using the dashboard 402 of the primary controller. For example, when the user 108 indicates a command to be executed associated with the secondary controller, the primary controller may use the user access rights associated with the secondary controller and send the command to the secondary controller, where the output of the secondary controller in response to the command may be displayed at the controller dashlet 404(2) of the dashboard 402 of the primary controller.

For example, controller dashlet 404(1) may include UI elements 406 for executing commands associated with the primary controller, where the primary controller may be configured to create security groups. As illustrated, UI elements 406 may include a UI element 406(1) for creating security groups, with information such as the security group name (UI element 406(2)), tag value (UI element 406(3)), and/or a general description (UI element 406(4)). Additionally, or alternatively, controller dashlet 404(2) may include UI elements 408 for executing commands associated with the secondary controller, where the secondary controller may configure security group access policies, such as authorization policies. As illustrated, UI elements 408 may include a UI element 408(1) with additional details regarding the security groups, as well as UI element 408(2) which may be used to configure authorization policies with respect to a security group.

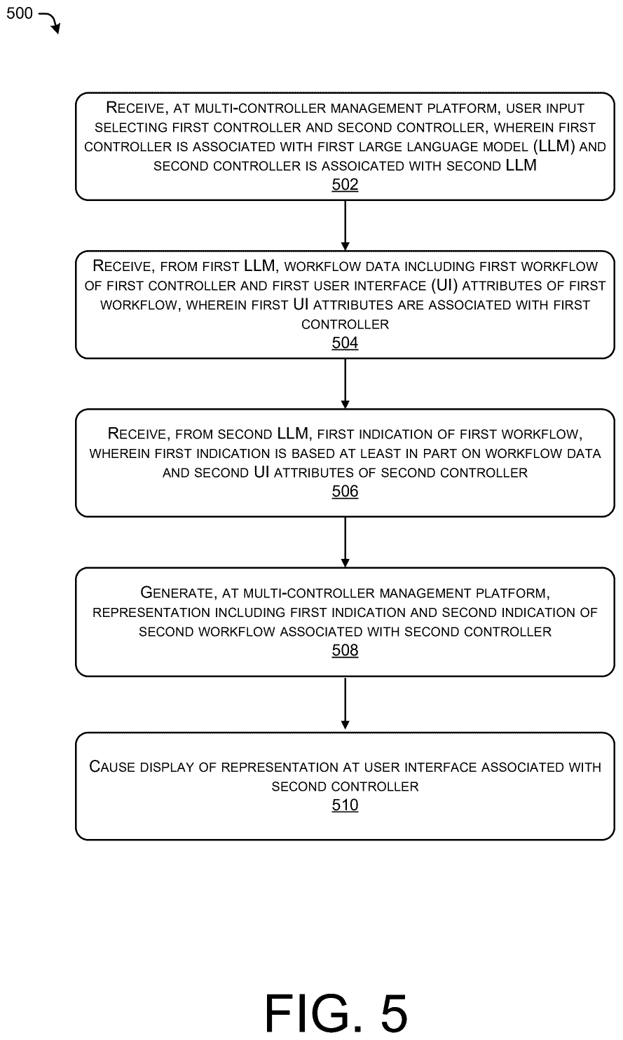

FIG. 5 illustrates a flow diagram of an example method 500 for the integration of controller data of a multi-controller environment using LLMs. The techniques may be applied by a system comprising one or more processors, and one or more non-transitory computer-readable media storing computer-executable instructions that, when executed by the one or more processors, cause the one or more processors to perform the operations of method 500.

The processes described herein are illustrated as collections of blocks in logical flow diagrams, which represent a sequence of operations, some or all of which may be implemented as hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 502, the method 500 may include receiving, at a multi-controller management platform, user input selecting a first controller and a second controller, wherein the first controller is associated with a first large language model (LLM) and the second controller is associated with a second LLM. For example, a system may be associated with a multi-controller management service, such as a management platform, at which a user may provide user input selecting a primary controller, such as the first controller described above. The user may select the primary controller based on a user preference, familiarity with the primary controller, access level, etc. Additionally, or alternatively, the user may select a secondary controller that the user would like to control. In some examples, the system may comprise multiple network controllers that may be present, or installed, in a network environment. The multiple network controllers may be configured to orchestrate network functions (e.g., monitor an inventory of devices in the network and their status, analyze network operations, automate device configurations, etc.). For example, a first controller may be associated with monitoring the overall operational status of network devices and/or configuring the network devices (e.g., routers, switches, etc.). Additionally, or alternatively, a second controller may be associated with authenticating users and configuring network access control, such as by enforcing policies. The second controller may also be configured to use data such as user group, device type, access time, access location, access type, and/or the like to create policies for network access. Additionally, or alternatively, the multiple network controllers may be associated with different access rights. For example, a user, such as a network administrator, may have an access level such that they are granted a general view of the controller, command access control, and/or the like.

The multiple network controllers may also each be associated, or embedded with, with a generative AI tool, such as an LLM. For example, the LLM may be configured to understand and generate human-like text in performing various tasks (e.g., text generation, responding to user input such as questions, text translation, etc.). In some instances, the LLM may be trained on large amounts of data, such as configuration data (e.g., a functionality and/or data type associated with a controller). The configuration data may include various command structures and/or workflows of the controller associated with the LLM. For example, an LLM associated with the first controller may be trained such that the LLM may receive user input data, such as in the form of a question and/or request, to configure a network device in a certain manner. The LLM may then output workflow data including the workflow and/or configuration commands for configuring the network device. In some instances, the workflow data may include a workflow and commands for monitoring the network and/or network objects.

Additionally, or alternatively, the LLM may be trained on the semantic data of the user interface (e.g., webpage) of its respective controller. For example, the LLM associated with the first controller may be trained on the semantic data of the first controller, and/or the LLM associated with the second controller may be trained on the semantic data of the second controller. The semantic data may include HyperText Markup Language (HTML) and/or Extensible Markup Language (XML) code representing the structure of the webpage, the content of the webpage, and/or the like. By way of example, and not limitation, the semantic data may include an indication such as pages and/or tabs included in the webpage. For example, the semantic data associated with the first controller may include an indication of tabs for monitoring the overall operational status of network devices. Additionally, or alternatively, the semantic data associated with the second controller may include an indication of tabs for creating policies for network access. The LLM of a network controller may be trained on the semantic data such that, in response to a user request, the LLM may output user interface data corresponding to workflows and/or commands for its respective controller. In some instances, the LLM of a network controller may be trained on the semantic data such that, in response to a user request, the LLM may output application programming interface (API) calls that may enable a user to remotely execute workflows associated with a controller functionality and via a user interface. The user interface data and/or API calls for a respective controller generated by an LLM may be included with the workflow data.

At block 504, the method 500 may include receiving, from the first LLM, workflow data including a first workflow of the first controller and first user interface (UI) attributes of the first workflow, wherein the first UI attributes are associated with the first controller. For example, the system may be configured to receive workflow data from the secondary controller. For example, using the LLM associated with the secondary controller, the LLM may output workflow data indicating commands and/or workflows associated with a task (e.g., configuring and/or monitoring a network device). In some instances, the LLM may output the workflow data associated with the task, where the task is provided as user input from a user. For example, the user may ask the LLM associated with the secondary controller to configure a user's rights in a network, monitor the battery status of certain network devices, monitor quality of service (QoS) data associated with an audio call, and/or the like. Accordingly, the LLM may output the corresponding configuration commands and/or workflows. In some instances, the commands and/or workflows included in the workflow data and output by the LLM may be based on access rights associated with the user (e.g., whether the user has access to generally view the controller, command access control, and/or the like).

Additionally, or alternatively, using the LLM associated with the secondary controller, the LLM may output the user interface data and/or API calls to remotely execute commands and/or workflows. In some instances, the LLM may output the user interface data and/or API calls associated with the configuration commands and/or workflows in response to user input. For example, the user may ask the LLM associated with the secondary controller to output user interface data and/or API calls associated with configuration commands and/or workflows described above. In some instances, such as when the user asks the LLM associated with the secondary controller to output user interface data associated with configuration commands and/or workflows, the LLM may output an HTML code representing a user interface associated with the execution of the configuration commands and/or workflows. For example, the HTML code may represent a user interface including tabs, pages, elements, and/or the like for configuring a user's rights in a network, monitoring the battery status of certain network devices, monitoring quality of service (QoS) data associated with an audio call, and/or the like. The configuration commands, workflows, user interface data, and/or API calls may be included as workflow data.

At block 506, the method 500 may include receiving, from the second LLM, a first indication of the first workflow, wherein the first indication is based at least in part on the workflow data and second UI attributes of the second controller. For example, upon receipt of the workflow data by the system, the workflow data may be used as input to the LLM associated with the primary controller, where the LLM associated with the primary controller may be configured to output translated workflow data. For example, based on the semantic data of the primary controller used to train the LLM associated with the primary controller, the LLM may output translated workflow data such that the workflow data of the secondary controller is translated to the structure and/or style (e.g., represented as HTML code, XML code, and/or the like) of the user interface of the primary controller. The workflow data may also include the user access rights associated with the secondary controller, which may be used by the LLM associated with the primary controller to output the translated workflow data.

At block 508, the method 500 may include generating, at the multi-controller management platform, a representation including the first indication and a second indication of a second workflow associated with the second controller. For example, the translated workflow data may indicate a representative tab, webpage, dashlet, etc. that may be in the structure and/or style of the primary controller, but includes elements for executing commands associated with the secondary controller. Additionally, or alternatively, the translated workflow data may be integrated into a user interface and/or dashboard such that the user interface includes a dashlet with elements for executing commands associated with the primary controller, as well as the integrated dashlet with elements for executing commands associated with the secondary controller.

At block 510, the method 500 may include causing display of the representation at a user interface associated with the second controller. For example, the user may use the integrated dashlet and elements for executing commands associated with the secondary controller using the user interface of the primary controller. For example, when the user indicates a command to be executed associated with the secondary controller, the primary controller may use the user access rights associated with the secondary controller and send the command to the secondary controller, where the output of the secondary controller in response to the command may be displayed at the dashlet of the user interface of the primary controller.

Additionally, or alternatively, the method 500 may include, wherein the user input is first user input, the workflow data is first workflow data, receiving second user input selecting the second controller and a third controller, wherein the third controller is associated with a third LLM, and receiving, from the third LLM, second workflow data indicating a third workflow of the third controller and third UI attributes of the third workflow, wherein the third UI attributes are associated with the third controller. The method 500 may further include receiving, from the second LLM, a third indication of the third workflow, wherein the third indication is based at least in part on the second workflow data and the second UI attributes of the second controller, generating, at the multi-controller management platform, a representation including the first indication, the second indication, and the third indication, and causing display of the representation at the user interface associated with the second controller

Additionally, or alternatively, the method 500 may include wherein the first LLM is trained to determine workflows associated with the first controller based at least in part on attributes associated with the first controller, and the second LLM is trained to determine workflows associated with the second controller based at least in part on attributes associated with the second controller.

Additionally, or alternatively, the method 500 may include, wherein the second LLM is trained to determine conflicts between workflows associated with the first controller and workflows associated with the second controller, determining, by the second LLM, a conflict between the first workflow and the second workflow, and retraining the second LLM to determine the workflows associated with the second controller based at least in part on the conflict.

Additionally, or alternatively, the method 500 may include wherein the attributes associated with the first controller and attributes associated with the second controller include at least one of a functionality associated with the first controller, a functionality associated with the second controller, UI semantic data associated with the first controller, and/or UI semantic data associated with the second controller.

Additionally, or alternatively, the method 500 may include wherein the workflow data further includes at least one of access rights associated with a user of the first controller, or application programming interface (API) commands associated with the first controller.

Additionally, or alternatively, the method 500 may include, wherein the user input is first user input, receiving, at the user interface associated with the second controller, second user input selecting a command associated with a functionality of the first controller, sending, by the second controller and to the first controller, and based at least in part on the access rights and the API commands associated with the first controller, command data indicating the command, receiving, at the second controller and from the first controller, output data responsive to the command data, and based at least in part on the output data, updating the representation

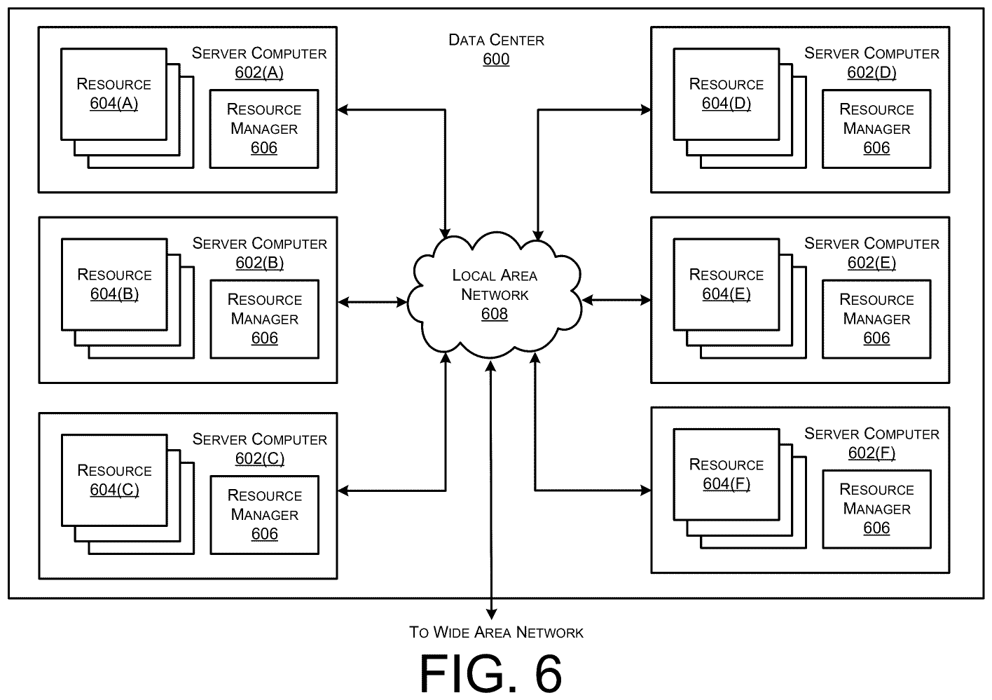

FIG. 6 is a computing system diagram illustrating a configuration for a data center 600 that can be utilized to implement aspects of the technologies disclosed herein. In one example, the data center 600 may be used to support a controller, such as controller 112. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the servers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the controller(s) 112 and/or the service provider network 102.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

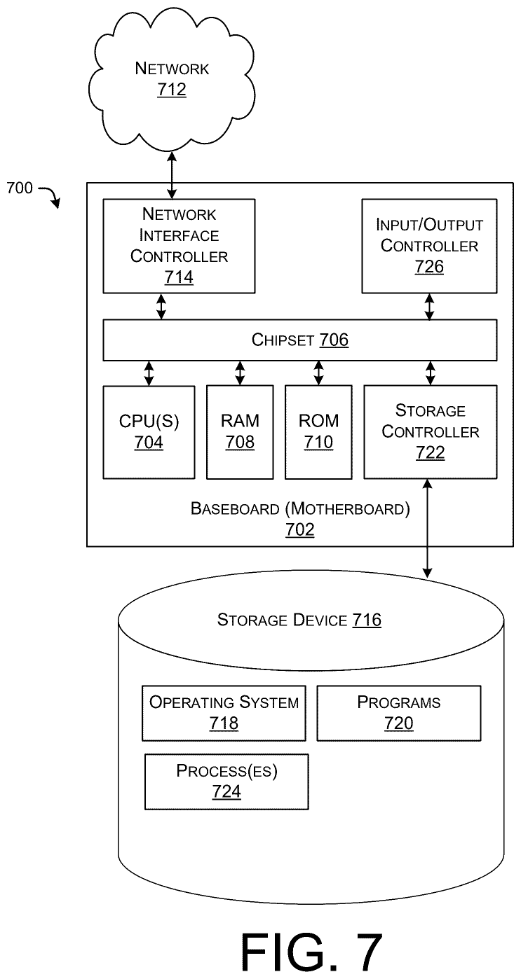

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a computer 700 (e.g., server computer) capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computer 700 may, in some examples, correspond to a physical server and may comprise networked devices such as servers, switches, routers, hubs, bridges, gateways, modems, repeaters, access points, etc.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a random-access memory (RAM) 708, used as the main memory in the computer 700. The chipset 706 can further provide an interface to a computer-readable storage medium such as a read-only memory (ROM) 710 or non-volatile RAM (NVRAM) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 712. The chipset 706 can include functionality for providing network connectivity through a network interface controller (NIC) 714, such as a gigabit Ethernet adapter. The NIC 714 is capable of connecting the computer 700 to other computing devices over the network 712. It should be appreciated that multiple NICs 714 can be present in the computer 700, connecting the computer 700 to other types of networks and remote computer systems. In some instances, the NICs 714 may include at least on ingress port and/or at least one egress port.

The computer 700 can be connected to a storage device 716 that provides non-volatile storage for the computer. The storage device 716 can store an operating system 718, programs 720, and data, which have been described in greater detail herein. The storage device 716 can be connected to the computer 700 through a storage controller 722 connected to the chipset 706. The storage device 716 can consist of one or more physical storage units. The storage controller 716 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 700 can store data on the storage device 716 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 716 is characterized as primary or secondary storage, and the like.

For example, the computer 700 can store information to the storage device 716 by issuing instructions through the storage controller 722 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 716 by detecting the physical states or characteristics of one or more particular locations within the physical storage units.

In addition to the mass storage device 716 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by any network node described herein may be supported by one or more devices similar to computer 700. Stated otherwise, some or all of the operations performed by a network node may be performed by one or more computer devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 716 can store an operating system 718 utilized to control the operation of the computer 700. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 716 can store other system or application programs and data utilized by the computer 700.

In one embodiment, the storage device 716 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

As illustrated in FIG. 7, the storage device 716 stores programs 720, which may include one or more processes 724. The programs 720 may comprise any type of programs or processes to perform the techniques described in this disclosure for the integration of network controllers. That is, the computer 700 may comprise any one of the routers, load balancers, and/or servers. The programs 720 may comprise any type of program that cause the computer 700 to perform techniques for communicating with other devices using any type of protocol or standard usable for determining connectivity. The process(es) 724 may include instructions that, when executed by the CPU(s) 704, cause the computer 700 and/or the CPU(s) 704 to perform one or more operations.

The computer 700 can also include at least one input/output controller 726 for receiving and processing input from a number of input devices, such as a keyboard, a mouse, a touchpad, a touch screen, an electronic stylus, or other type of input device. Similarly, an input/output controller 726 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A system comprising:
one or more processors; and
one or more non-transitory computer-readable media storing computer-executable instructions that, when executed by the one or more processors, cause the one or more processors to perform operations comprising:
receiving, at a multi-controller management platform, user input selecting a first controller and a second controller, wherein the first controller is associated with a first large language model (LLM) and the second controller is associated with a second LLM;
receiving, from the second LLM, a first indication of a first workflow associated with the first controller, wherein the first indication is based at least in part on the first workflow and second UI attributes of the second controller;
generating, at the multi-controller management platform, a representation including the first indication and a second indication of a second workflow associated with the second controller; and
causing display of the representation at a user interface associated with the second controller.

2. The system of claim 1, wherein the user input is first user input, the operations further comprising:
receiving second user input selecting the second controller and a third controller, wherein the third controller is associated with a third LLM;
receiving, from the second LLM, a third indication of a third workflow associated with the third controller, wherein the third indication is based at least in part on the second workflow and the second UI attributes of the second controller;
generating, at the multi-controller management platform, a representation including the first indication, the second indication, and the third indication; and
causing display of the representation at the user interface associated with the second controller.

3. The system of claim 1, wherein:
the first LLM is trained to determine workflows associated with the first controller based at least in part on attributes associated with the first controller; and
the second LLM is trained to determine workflows associated with the second controller based at least in part on attributes associated with the second controller.

4. The system of claim 3, wherein the second LLM is trained to determine conflicts between workflows associated with the first controller and workflows associated with the second controller, the operations further comprising:
determining, by the second LLM, a conflict between the first workflow and the second workflow; and
retraining the second LLM to determine the workflows associated with the second controller based at least in part on the conflict.

5. The system of claim 3, wherein the attributes associated with the first controller and attributes associated with the second controller include at least one of:
a functionality associated with the first controller;
a functionality associated with the second controller;
UI semantic data associated with the first controller; or
UI semantic data associated with the second controller.

6. The system of claim 1, wherein the first workflow further includes at least one of:
access rights associated with a user of the first controller; or
application programming interface (API) commands associated with the first controller.

7. The system of claim 6, wherein the user input is first user input, the operations further comprising:
receiving, at the user interface associated with the second controller, second user input selecting a command associated with a functionality of the first controller;
sending, by the second controller and to the first controller, and based at least in part on the access rights and the API commands associated with the first controller, command data indicating the command;
receiving, at the second controller and from the first controller, output data responsive to the command data; and
based at least in part on the output data, updating the representation.

8. A method for multi-controller management, the method comprising:
receiving, at a multi-controller management platform, user input selecting a first controller and a second controller, wherein the first controller is associated with a first large language model (LLM) and the second controller is associated with a second LLM;
receiving, from the first LLM, workflow data including a first workflow of the first controller and first user interface (UI) attributes of the first workflow, wherein the first UI attributes are associated with the first controller;
receiving, from the second LLM, a first indication of the first workflow, wherein the first indication is based at least in part on the workflow data and second UI attributes of the second controller;
generating, at the multi-controller management platform, a representation including the first indication and a second indication of a second workflow associated with the second controller; and
causing display of the representation at a user interface associated with the second controller.

9. The method of claim 8, wherein the user input is first user input, the workflow data is first workflow data, the method further comprising:
receiving second user input selecting the second controller and a third controller, wherein the third controller is associated with a third LLM;
receiving, from the third LLM, second workflow data indicating a third workflow of the third controller and third UI attributes of the third workflow, wherein the third UI attributes are associated with the third controller;
receiving, from the second LLM, a third indication of the third workflow, wherein the third indication is based at least in part on the second workflow data and the second UI attributes of the second controller;
generating, at the multi-controller management platform, a representation including the first indication, the second indication, and the third indication; and
causing display of the representation at the user interface associated with the second controller.

10. The method of claim 8, wherein:
the first LLM is trained to determine workflows associated with the first controller based at least in part on attributes associated with the first controller; and
the second LLM is trained to determine workflows associated with the second controller based at least in part on attributes associated with the second controller.

11. The method of claim 10, wherein the second LLM is trained to determine conflicts between workflows associated with the first controller and workflows associated with the second controller, the method further comprising:
determining, by the second LLM, a conflict between the first workflow and the second workflow; and
retraining the second LLM to determine the workflows associated with the second controller based at least in part on the conflict.

12. The method of claim 10, wherein the attributes associated with the first controller and attributes associated with the second controller include at least one of:
a functionality associated with the first controller;
a functionality associated with the second controller;
UI semantic data associated with the first controller; or
UI semantic data associated with the second controller.

13. The method of claim 8, wherein the workflow data further includes at least one of:
access rights associated with a user of the first controller; or
application programming interface (API) commands associated with the first controller.

14. The method of claim 13, wherein the user input is first user input, the method further comprising:
receiving, at the user interface associated with the second controller, second user input selecting a command associated with a functionality of the first controller;
sending, by the second controller and to the first controller, and based at least in part on the access rights and the API commands associated with the first controller, command data indicating the command;
receiving, at the second controller and from the first controller, output data responsive to the command data; and
based at least in part on the output data, updating the representation.

15. One or more non-transitory computer-readable media storing computer-executable instructions that, when executed by one or more processors, cause the one or more processors to perform operations comprising:
receiving, at a multi-controller management platform, user input selecting a first controller and a second controller, wherein the first controller is associated with a first large language model (LLM) and the second controller is associated with a second LLM;
receiving, from the first LLM, workflow data including a first workflow of the first controller and first user interface (UI) attributes of the first workflow, wherein the first UI attributes are associated with the first controller;
receiving, from the second LLM, a first indication of the first workflow, wherein the first indication is based at least in part on the workflow data and second UI attributes of the second controller;
generating, at the multi-controller management platform, a representation including the first indication and a second indication of a second workflow associated with the second controller; and
causing display of the representation at a user interface associated with the second controller.

16. The one or more non-transitory computer-readable media of claim 15, wherein the user input is first user input, the workflow data is first workflow data, the operations further comprising:
receiving second user input selecting the second controller and a third controller, wherein the third controller is associated with a third LLM;
receiving, from the third LLM, second workflow data indicating a third workflow of the third controller and third UI attributes of the third workflow, wherein the third UI attributes are associated with the third controller;
receiving, from the second LLM, a third indication of the third workflow, wherein the third indication is based at least in part on the second workflow data and the second UI attributes of the second controller;
generating, at the multi-controller management platform, a representation including the first indication, the second indication, and the third indication; and
causing display of the representation at the user interface associated with the second controller.

17. The one or more non-transitory computer-readable media of claim 15, wherein:
the first LLM is trained to determine workflows associated with the first controller based at least in part on attributes associated with the first controller; and
the second LLM is trained to determine workflows associated with the second controller based at least in part on attributes associated with the second controller.

18. The one or more non-transitory computer-readable media of claim 17, wherein the second LLM is trained to determine conflicts between workflows associated with the first controller and workflows associated with the second controller, the operations further comprising:
determining, by the second LLM, a conflict between the first workflow and the second workflow; and
retraining the second LLM to determine the workflows associated with the second controller based at least in part on the conflict.

19. The one or more non-transitory computer-readable media of claim 17, wherein the attributes associated with the first controller and attributes associated with the second controller include at least one of:
a functionality associated with the first controller;
a functionality associated with the second controller;
UI semantic data associated with the first controller; or
UI semantic data associated with the second controller.

20. The one or more non-transitory computer-readable media of claim 15, wherein the user input is first user input, the operations further comprising:
receiving, at the user interface associated with the second controller, second user input selecting a command associated with a functionality of the first controller;
sending, by the second controller and to the first controller, and based at least in part on access rights associated with a user of the first controller and application programming interface (API) commands associated with the first controller, command data indicating the command;
receiving, at the second controller and from the first controller, output data responsive to the command data; and
based at least in part on the output data, updating the representation.
